(19) United States
(12) Patent Application Publication
(10) Pub. No.: US 2005/0077335 A1
(43) Pub. Date: Apr. 14, 2005

(54) Kayak carrier for vehicle roof rack

(76) Inventor: Grayson Bourne, Pelham, NY (US)

Correspondence Address: Donald W. Meeker;Patent Agent, #E, 924 East Ocean Front, Newport Beach, CA, 92661, US

(21) Appl. No.: 10/683,368

(22) Filed: Oct. 9, 2003

(51) Int. Cl. B60R 9/00

(52) U.S. Cl. 224/319; 224/321

(57) ABSTRACT

A pair of padded rigid-V one-piece kayak carrier supports with integral channel mounts mount on the cross arms of an existing roof rack. An elasticized cord loop stretches over the ends of each of the cradles and under externally protruding pegs. A telescoping cross bar may interconnect the two cradles with sliding mating channel connectors to attach the cross bar to the cross arms of the roof rack.

### BACKGROUND OF THE INVENTION

1. Field of the Invention

The present invention relates to the field of kayak carriers that mount on a vehicle rooftop, and particularly to a pair of padded rigid-V one-piece kayak carrier supports that mount on an existing roof rack.

2. Description of the Prior Art

It is often a headache to transport racing and sea kayaks. Loading them onto a vehicle generally includes messing with straps and boat damage. Arrangements are previously known in the art for transporting kayaks and similar craft, these arrangements have obliquely directed support portions which are secured on the load carrier beam so that a craft resting thereon is prevented from being displaced in a lateral direction. Clamping straps are also employed that extend about the load carrier beam for lashing the craft in position.

Most prior art devices provide boat supports which are adjustable in the width of the cradle supporting the boats to accommodate various types and sizes of boats. These prior art boat supports lack a rigid structure and rigid means of securing to a roof rack. The separate parts screwed together for adjustment rely on the skill and strength of the user to insure a solid cradle and solid connection of the cradle to the roof rack. Due to the very high wind lift forces encountered in high-speed highway driving, boats may be lifted from a roof rack support which is not rigidly secured.

Prior art U.S. Pat. No. 4,081,118, issued Mar. 28, 1978 to Mason, provides a carrier for use in supporting, for example, a canoe on a vehicle roof has a base which is adapted for clamping the carrier onto a roof rack which is to be mounted on the vehicle, and a pair of laterally spaced limbs which extend upwardly from the base and define a cradle for supporting the canoe. The limbs are preferably laterally adjustable for altering the width of the cradle. Usually a pair of the carriers will be mounted on the roof rack for supporting the canoe at spaced positions along its length.

Prior art U.S. Pat. No. 5,957,350, issued Sep. 28, 1999 to Giles, puts forth a kayak loading device that employs guiding rollers and roof rack attachment mechanism. The device allows one person to easily and conveniently load a kayak or similar article onto an automobile's roof rack. The device comprises several freely rotating rollers oriented in a “V” configuration by rigid struts attached to a crossmember. Padded feet flexibly mounted to vertical stanchions extending downward from the crossmember support the rear most portion of the loading device. An attachment mechanism extends forward from the crossmember, which securely latches the loading device onto a vehicle's roof rack crossbar. Loading a kayak requires first positioning a kayak's bow into the vertex of the rollers. The stem of the kayak is then pushed upwardly and forwardly along the rollers onto the automobile's roof rack. The device is removed from the automobile's roof rack after the kayak is loaded.

Prior art U.S. Pat. No. 4,239,137, issued Dec. 16, 1980 to Arcouette, shows a carrier and stand device for a boat, such as a canoe, and, in particular, a kayak, which is characterized by its structural advantages as well as for its versatility for use during any phase of the boat life from production to the user, including transportation, storage and display. This device includes a pair of transverse U-shape frames and connector rods allowing to disconnect the pair of frames and compactly store away the components during non-use. The frames are provided with sets of sockets and projections allowing positive stacking of a plurality of such devices in a number of different ways for convenience in storage and display.

Prior art U.S. Pat. No. 5,516,017, issued May 14, 1996 to Arvidsson, describes an arrangement for carrying a craft such as a kayak or a surfboard. The arrangement includes a carrier bar that extends across a vehicle roof, which is fastened to opposite edge portions thereof. Holders are provided for engagement with the carrier bars. The holders are provided with arrangements for fixing the holders in selected positions along the carrier bars. Support members for the craft are made from a flexible material and are fastened to the holders pivotally about axes extending lengthwise of the vehicle. At least two arms are provided with each arm being fastened at a first end thereof to each holder and being pivotable about a pivot axis extending lengthwise of the vehicle. The arms have their free ends connected to the support member pivotally above an axis extending lengthwise of the vehicle such that pivoting of the arms adjusts the shape and position of the support members for a particular craft to be carried.

Prior art U.S. Pat. No. 5,775,557, issued Jul. 7, 1998 to Arvidsson, discloses an arrangement for carrying a craft such as a kayak or a surfboard. The arrangement includes a carrier bar that extends across a vehicle roof, which is fastened to opposite edge portions thereof. Holders are provided for engagement with the carrier bars. The holders are provided with arrangements for fixing the holders in selected positions along the carrier bars. Support members for the craft are made from a flexible material and are fastened to the holders pivotally about axes extending lengthwise of the vehicle. At least two arms are provided with each arm being fastened at a first end thereof to each holder and being pivotable about a pivot axis extending lengthwise of the vehicle. The arms have their free ends connected to the support member pivotally above an axis extending lengthwise of the vehicle such that pivoting of the arms adjusts the shape and position of the support members for a particular craft to be carried.

Prior art U.S. Pat. No. 6,164,507, issued Dec. 26, 2000 to Dean, depicts a boat rack apparatus for carrying a boat on a vehicle roof rack, which has a selectively engageable gripping surface. The apparatus includes one or more mounts configured for attachment adjacent a vehicle. Each mount includes a support region that has a support surface constructed to slidably receive and support a boat above a vehicle roof, and a gripping pad that is movable from a recessed position to a protruding position to restrain the boat from sliding across the support surface. A securing strap is positionable over at least a portion of the boat and configured to hold the boat against the support regions when the strap is tightened. The securing strap passes around the gripping pad to move the pad to the protruding position and press it into contact with the boat. One or more connectors are optionally provided to attach the mounts to roof rack or boat trailer. The securing strap includes a lever-actuated buckle to join opposite ends of the securing strap. A buckle protective housing is optionally provided to protect the boat from damage by the buckle. The buckle housing includes an access hole adjacent the buckle lever. The access hole extends through at least a portion of a top and side surface of the housing to allow a user to operate the lever.

What is needed is a pre-sized rigid-V one-piece rigid padded cradle to receive the kayak instantly by placing it between a pair of the cradles with each cradle having a built-in pre-sized channel mount for a precise fit to a roof rack cross bar with each cradle having protruding top outside pegs so that an elasticized cord loop can be instantly hooked over the kayak and under the pegs on each cradle.

### SUMMARY OF THE INVENTION

An object of the present invention is to provide a pre-sized rigid-V one-piece rigid padded cradle to receive the kayak instantly by placing it between a pair of the cradles with each cradle having a built-in pre-sized channel mount for a precise fit to a roof rack cross bar with each cradle having protruding top outside pegs so that an elasticized cord loop can be instantly hooked over the kayak and onto the cradle ends under the pegs.

Another object of the present invention is to provide a pair of aligned padded rigid-V cradles which are presized for the kayak for exact fit so that the kayak need only be positioned between the cradles and tied down with elasticized cord loops which attach instantly under the outside protruding peg at the end of each side of each cradle to eliminate the headache of racing and sea kayak transport. The tie-down system eliminates messing with straps and boat damage by providing simple kayak slide-in and stretch over loop fastening, which system offers ten-second tie-down and security for even the bumpiest rides.

One more object of the present invention is to provide a kayak carrier that has a pre-sized channel mount for a precise fit to an existing roof rack, thereby saving money for the user who has interests in several sports which require roof rack to transport their equipment.

An additional object of the present invention is to provide an alternate embodiment of the invention in which the pair of cradles are each rigidly pre-attached to a telescopically adjustable cross bar located between the cradles.

In brief, a pair of rigid-V one-piece pre-shaped kayak support cradles, are each mounted to one of a pair of roof rack cross bars and aligned to receive a kayak resting between the cradles. Each cradle has a built-in pre-sized channel mount for a precise fit to an existing roof rack cross bar. The kayak may be received instantly by placing it between the pair of the cradles. Each cradle has protruding top outside pegs so that an elasticized cord loop can be instantly stretched between the ends of the cradle under the pegs and over the kayak, thereby securing the kayak.

An alternate embodiment of the invention is provided in which the pair of cradles are each rigidly pre-attached to a cross bar between the cradles.

An advantage of the present invention is that it eliminates the headache of racing and sea kayak transport by using a presized padded cradle with an instantly stretched and secured elastic cord loop so that there is no more messing with straps, no more boat damage, just a simple slide-in and elastic cord loop fastening system offering ten-second tie-down and security for even the bumpiest rides.

Another advantage of the present invention is that it accommodates all standard racing kayaks and most sea kayaks.

A further advantage of the present invention is that it provides greater longitudinal stability—a must for longer kayaks—no bounce and need to tie down boat ends.

A corollary advantage of the present invention is that it provides improved hull support, reducing point pressure on delicate hulls and seams.

One more advantage of the present invention is that it provides ease of loading since one end can be loaded at a time.

Yet another advantage of the present invention is that it provides a ten second elastic cord loop tie-down system.

An additional advantage of the present invention is that it causes less damage caused to the kayaks by using elastic cord loops than harsh fabric straps.

Still another advantage of the present invention is that it is compatible with commonly used cross bar roof racks.

A longevity advantage of the present invention is that it provides a sleek, non-rust powder coat impact resistant finish for long term durability.

One additional advantage of the present invention is that it provides a model for virtually every kayak available.

A still further advantage of the present invention is that it provides a longer version structured to accommodate slightly wider boats, racing kayaks, or single rowing sculls.

Still one more advantage of the present invention is that it provides an 8-foot brace between cradles which gives greater longitudinal support and can accommodate wider kayaks (up to 17″ at 8′ span).

An advantage of the present invention is that it is pre-sized to fit the kayak to insure secure transportation of the kayak.

Another advantage of the present invention is that it may be used with an existing roof rack with channel mounts pre-sized to fit the roof rack for a tight secure fit.

A further advantage of the present invention is that it is lightweight and easy to install.

An additional advantage of the present invention is that the kayak may be loaded easily by one person.

Yet another advantage of the present invention is that it is inexpensive to manufacture.

Still another advantage of the present invention is that it offers a simple fastening system.

One more advantage of the present invention is that the kayak is very secure when tied down.

### BRIEF DESCRIPTION OF THE DRAWINGS

These and other details of my invention will be described in connection with the accompanying drawings, which are furnished only by way of illustration and not in limitation of the invention, and in which drawings:

FIG. 1 is a perspective view of a pair of the rigid-V one-piece pre-shaped kayak support cradles of the invention, each mounted to one of a pair of roof rack cross bars and aligned to receive a kayak resting between the cradles;

FIG. 2 is an end elevational view of one of the kayak support cradles of FIG. 1 shown supporting one end of a kayak with an elasticized cord loop stretched over the kayak and hooked under the protruding pegs on the outside top of each side of the cradle;

FIG. 3 is a side elevational view of a vehicle having each of the two cradles of FIG. 1 mounted on one of a pair of roof racks supporting a kayak between the two cradles with an elasticized cord loop stretched over the kayak and hooked under the pegs on each cradle to hold down the kayak;

FIG. 4 is a perspective view an alternate embodiment of the pair of cradles each rigidly pre-attached to a cross bar between the cradles;

FIG. 5 is a side elevational view of a vehicle with the two cradles rigidly attached to the cross bar of FIG. 4 mounted on a pair of roof racks supporting a kayak between the two cradles with an elasticized cord loop stretched over the kayak and hooked under the pegs on each cradle to hold down the kayak.

### BEST MODE FOR CARRYING OUT THE INVENTION

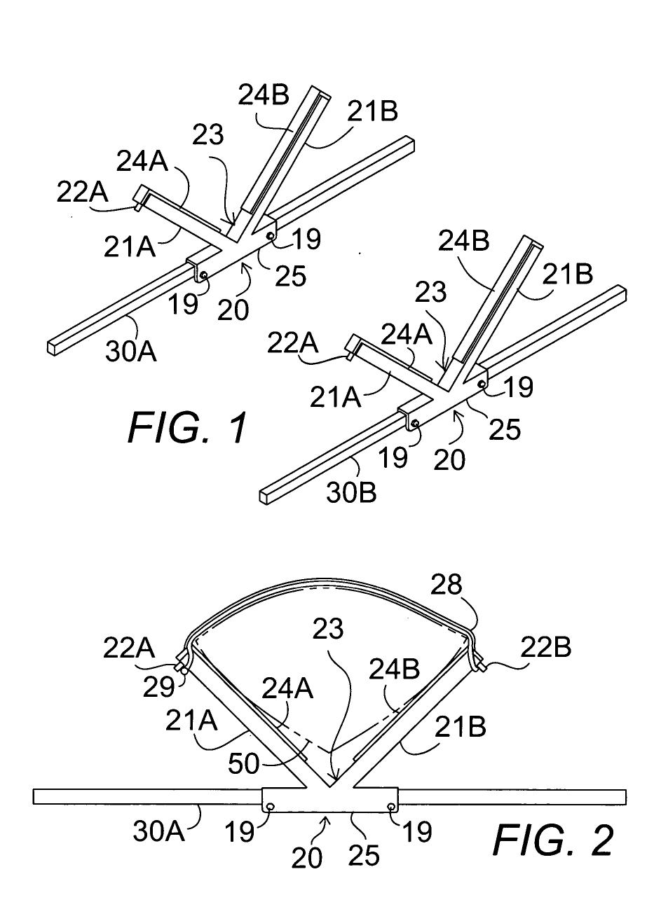

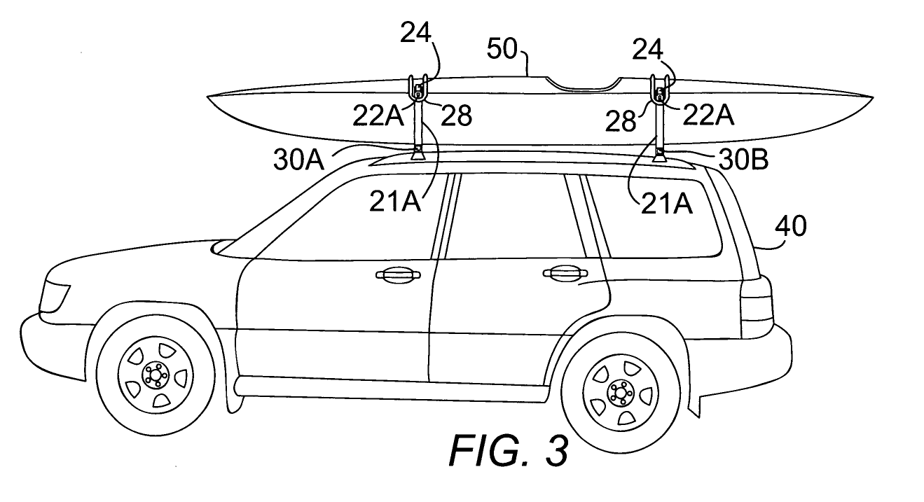

In FIGS. 1-3, a kayak carrier device 20 for securing a kayak 50 to the cross arms 30A and 30B of a roof rack of a vehicle 40, the device 20 comprises a pair of rigid V-shaped one-piece cradles 23. Each of the cradles 23 is formed in a rigid one-piece V shape 23 with two arms 21A and 21B permanently interconnected to form the V shape. Each of the cradles 23 is pre-sized to support a hull of a kayak 50 within the V shape on the two arms 21A and 21B. The two arms 21A and 21B are each rigidly attached with a permanent one-piece connection to a mounting channel 25 at a bottom of the V shape 23. The V-shape 23 and the mounting channel 25 are preferably formed of weatherproof metal welded together to form a single piece 20. The mounting channel 25 is pre-sized and pre-structured to fit with a tight friction fit over a cross arm 30A or 30B of a roof rack, so that the pair of cradles 23 with one on each of the pair of spaced roof racks 30A or 30B may be aligned to receive a kayak 50 therebetween, as shown in FIG. 3. The mounting channels 25 are secured to the cross arms 30A and 30B by bolts 19 screwed between the side edges of the mounting channels below the cross arms. Each of the arms 21A and 21B has a layer of padding 24A and 24B respectively, that extends from an inside face of the arm over a top end of the arm. Each of the arms 21A and 21B of the V shape cradle 23 has a protruding peg 22A and 22B respectively, on the outside face, adjacent to the top end of the arm 21A or 21B.

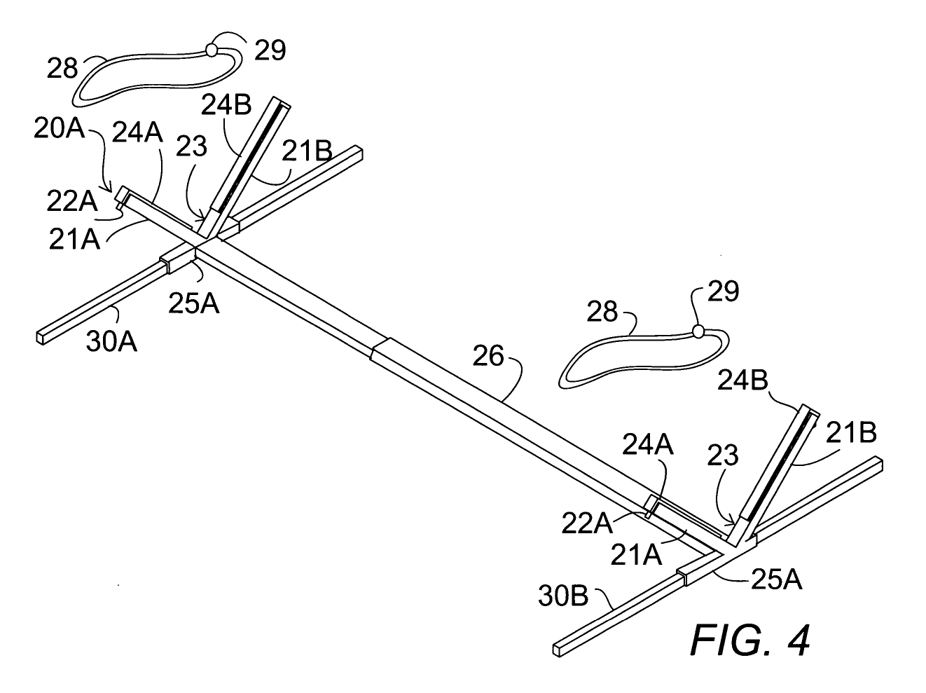

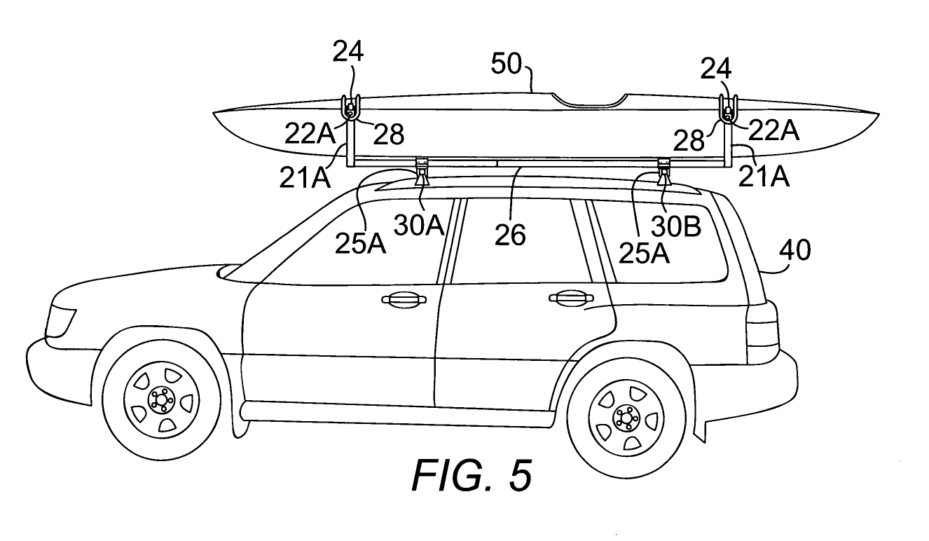

In FIGS. 4 and 5, an alternate kayak carrier 20A may further comprise a rigid cross bar 26 permanently attached between the two cradles 23 with a rigid one-piece connection to each of the cradles 23. The rigid cross bar 26 is preferably formed in two telescoping sections secured together by a screw means (not shown) and adjustable in length to telescope closed for storage and telescope open to accommodate the length of the kayak. The cross bar 26 is attached to each of the cross arms 30A and 30B of the roof rack by an inverted channel 25A under each of the cross arms bolted by a pair of bolts 19A to each side of a flanged channel 18 set down over the cross bar 26 with a plate 17 between the flanged channel 18 and the inverted channel 25A. The double channel attachments can be adjusted to fit any spacing of roof rack cross arms. The cross bar 26 provides full support for the kayak 50 even on vehicles with small roofs and eliminates the need for tie downs at the ends of the kayak for fast loading and unloading.

The kayak carrier device 20 and 20A also comprises a pair of elasticized cord loops 28, with each cord 28 having a sphere 29 connector to connect the two ends of the cord together to form the loop. The elasticized cords 28 can stretch with a tight fit over a kayak 50, which rests on both of the cradles 23, as shown in FIGS. 3 and 5. Each of the elasticized cord loops 28 is hooked around one of the arms 21A or 21B of one of the cradles 23 under the protruding peg 22A or 22B, as shown in FIGS. 2, 3 and 5.

In practice, the V-shaped cradles 23 of the carrier 20 would be mounted on the existing roof rack cross arms 30A and 30B, one cradle 23 per each cross arm 30A or 30B, with the mounting channels 25 fitting snugly on the cross arms 30A or 30B. The kayak 50 would be positioned in the V-shaped cradles 23 resting on the padding 24A and 24B of both cradles 23, as shown in FIG. 2. The kayak 50 would be secured in place by attaching one end of each of the elasticized cord loops 28 over an end of an arm 21A or 21B of the cradle, such an elasticized cord 28 looped over the peg 22A of the first arm 21A of the cradle 23 and then stretching the cord 28 tightly over the kayak 50 and looping the opposite end of the elasticized cord loop 28 over the second arm 21B of the cradle 23 with the loop under the protruding peg 22B. The kayak 50 would be secured in this manner on both cradles 23, as shown in FIG. 3.

In practice, the length of the crossbar 26 of the alternate embodiment 20A would be adjusted by moving its two telescoping sections to accommodate the length of the kayak and the mounting channels 25A attached to the roof rack cross arms 30A and 30B. The kayak 50 would be placed onto the V-shaped cradles 23 resting on the padding 24A and 24B. The kayak 50 would be secured in place by attaching one end of an elasticized cord 28 over the peg 22A of the first arm 21A of the cradle 23 and then stretching the cord 28 tightly over the kayak 50 and attaching the end of the cord 28 around the second arm 21B of the cradle under the protruding peg 22B. The kayak would be secured in this manner on both cradles, as shown in FIG. 5.

The present invention comprises non-rusting lightweight aluminum kayak carriers with all stainless steel bolts.

It is understood that the preceding description is given merely by way of illustration and not in limitation of the invention and that various modifications may be made thereto without departing from the spirit of the invention as claimed.

1. A kayak carrier device for securing a kayak to a roof rack of a vehicle, the device comprising:
a pair of rigid V-shaped one-piece cradles, each of the cradles formed into a rigid one-piece V shape with two arms permanently interconnected to form the V shape, each of the cradles pre-sized to support a hull of a kayak within the V shape on the two arms, the two arms rigidly attached with a permanent one-piece connection to a mounting element at a bottom of the V shape, the mounting element having a pair of channels each pre-sized and pre-structured to fit with a tight friction fit and secured by a securing means to each of a pair of spaced cross arms of a roof rack so that the pair of cradles are capable of being aligned to receive a kayak therebetween, each of the arms having a layer of padding extending over an inside face of each of the arms and over a top end of each of the arms, each of the arms having a protruding peg on an outside face of each of the arms adjacent to the top end,
a pair of elasticized cord loops, each of the elasticized cord loops capable of stretching with a tight fit over a kayak resting on both of the cradles with the elasticized cord loop hooked around both of the arms of one of the cradles under the protruding peg.

2. The kayak carrier of claim 1 wherein the channel is permanently attached to the interconnected arms of each of the cradles with the channel facing downwardly to fit over one of the cross arms of the roof rack with a pair of vertical sides of the channel extending below the cross arm and the securing means comprises a pair of bolts secured between the vertical sides below the cross arm to form the mounting element.

3. The kayak carrier of claim 2 wherein the arms and the mounting channel are formed of metal welded together to form a single piece.

4. The kayak carrier of claim 1 further comprising a rigid cross bar permanently attached between the two cradles with a rigid one-piece connection to each of the cradles.

5. The kayak carrier of claim 4 wherein the rigid cross bar is formed in at least two telescoping sections secured together by a screw means to make the cross bar collapsible and expandable and adjustable in length.

6. The kayak carrier of claim 4 wherein the pair of channels are adjustably mounted on the cross bar with the channels facing up and fitting under the cross arms and the securing means comprises a mating pair of channels with flanges mounted over the cross bar with the mating pair of channels facing downwardly and the flanges connected to each of two upfacing edges of the pair of channels by an adjustable connecting means.

7. The kayak carrier of claim 6 wherein the flanges are each provided with a pair of holes therethrough and the upfacing edges of the pair of channels are each provided with a pair of mating threaded and the adjustable connecting means comprises two threaded screw means through the flange holes into the threaded channel holes.
